(19) United States
(12) Patent Application Publication
(10) Pub. No.: US 2004/0202752 A1
(43) Pub. Date: Oct. 14, 2004

(54) Drip-proof food packaging

(76) Inventor: Hee Chan Chung, Naples, FL (US)

Correspondence Address: Hee Chan Chung, Suite 12, 1719 Trade Center Way, Naples, FL, 34109, US

(21) Appl. No.: 10/412,494

(22) Filed: Apr. 14, 2003

(51) Int. Cl. A23B 4/00

(52) U.S. Cl. 426/115

(57) ABSTRACT

The invention is directed to a way of eating fast foods in restaurants and in drive-through eating establishments that serve hot or cold foods. In either case, the food is served at a counter or in a drive-through environment. The food is delivered either through a window or across a counter. The problem is that the food is contained either in a wrapping or a container. When eating the food, it happens that the eater of the food, either at home or in car, experiences food spills. The gist of the invention at hand is that the device, while eating, does not soil the fingers of the user or the clothing will not be soiled by any food spills. The invention involves a conical collar that has a wider opening at its upper end than at its lower end. This type of collar will allow a food item to be consumed without spilling fluids or particles of food because the upper end of the collar opens wide to include the mouth of the eater including the chin

### CROSS REFERENCE TO RELATE APPLICATIONS

(none)

### STATEMENT REGARDING FED SPONSORED R & D

(none)

### BACKGROUND OF THE INVENTION

This invention is directed to the subject of packaging consumable foods, especially to the kinds of foods that are served at fast food establishments. More particularly yet to drive-through-windows. It is well known that hamburgers, for example, are being served or up till now have been served in Styrofoam cases. Other servings are being handed through the drive-through windows just wrapped in paper. Of course, the food or foods purchased are handed to the consumer in a bag including the drink or drinks ordered at the same time The customer will now park in a parking lot or continue to drive and at the same time will consume the food. This creates a problem that this invention will try to prevent. That is, the spilling of food or drips from the food. Unless unusual numbers of napkins or like material are used, the drippings can hardly be avoided, especially, soiling the clothing.

### DISCUSSION OF THE PRIOR ART

U.S. Pat. No. 4,033,013 illustrates an open top case that has magnetic pieces attached at the top opening to keep the case closed.

U.S. Pat. No. 5,037,138 shows a reclosable package for containing and protecting a product disposed therein including an initial seal and a reusable snap-closure

U.S. Pat. No. 5,094,863 illustrates a food packaging material for a variety of food service applications including fast food restaurants. The packaging is formed from a material that is formed into a receptacle having a shape suitable for enclosing and sealing fast food sandwiches and the like. There is no mention of including any items for preventing any spills or drippings on any clothing while eating the food.

U.S. Pat. No. 6,290,121 shows a more convenient, user-friendly and less messy packaging that enables the eater to cleanly and hygienically hold and handle various food items and expose one bite sized portion at a time. There is no mention at all of how any drips and pieces of food are prevented from soiling the clothing while eating.

U.S. Pat. No. 6,335,042 shows a food package comprising a tray formed from a card having a rectangular base with fold up side and end walls and a sheet of wrapping extending over the tray and adhering to the side walls to receive a food item. Again there is no mention of how drips are prevented from escaping the package while a person is eating.

### BRIEF SUMMARY AND OBJECTS OF THE INVENTION

On object of the invention is to provide a device or an item that would prevent the above noted problems while consuming packaged foods. This device simply consists of a collar of a somewhat stiff material into which the packaged food is inserted or the collar participates in the packaging of the food. When a person sitting or driving in an automobile, for example, is ready to eat the fast food, just obtained from a drive-through-window, the collar is opened and then spread apart, the collar is opened to a size whereby the collar will surround the mouth of the person including the chin, whereby any food drippings will be contained within the collar and most likely will be returned into the package. This collar can be made of rather stiff paper, a corrugated cardboard or some plastic material such as vinyl and other plastics. If it is made of a paper material, it is environmentally friendly because this material will easily decompose and/or deteriorate.

Even if the collar is connected to a depending bag, the bag would also be made of a material that easily decomposes

### BRIEF DESCRIPTION OF THE DRAWINGS

FIG. 1 shows a conical collar about to receive food in a package;

FIG. 2 shows a conical collar after the packaged food has been received therein;

FIG. 3 illustrates a collar with a food bag attached to the bottom thereof;

FIG. 4 shows the conical collar of FIG. 3 with a food item contained in the bag;

FIG. 5 shows how the collar operates to prevent any spilling of food on the clothing;

FIG. 6 shows the operation of FIG. 5 with a longer bag attached to the collar;

FIG. 7 shows a perspective view of a different embodiment of the invention

FIG. 8 shows a side view of the embodiment of FIG. 7

FIG. 9 is a top view of the embodiment of FIGS. 7 and 8 prior to turning the food item by 90°;

FIG. 10 shows the same top view of FIG. 9 after the food item has been turned by 90°.

### DETAILED DESCRIPTION OF THE INVENTION

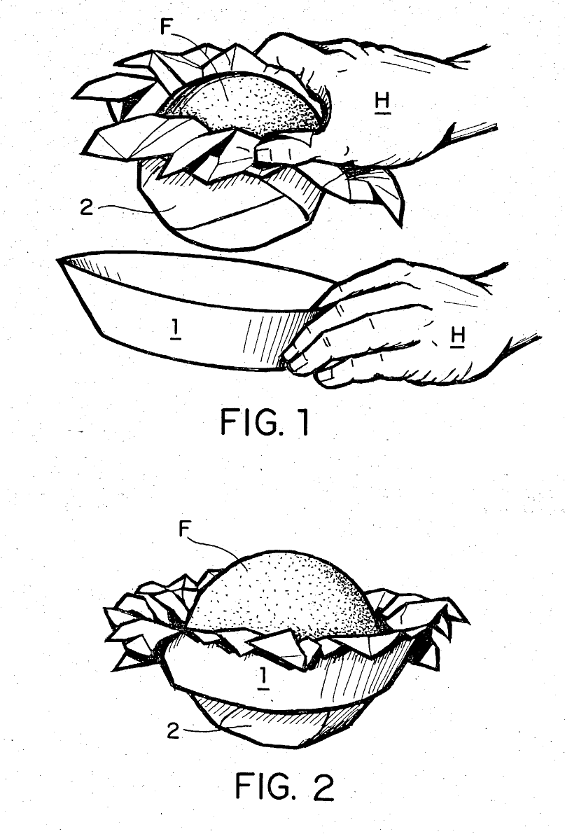

Turning now to FIG. 1, there is shown a perspective view of a food item F, such as a hamburger which is wrapped in wrapping 2, as it is about to be placed into the inventive collar 1. The collar 1 is in a conical shape in the form of a crown with the wider shape or opening being directed upwardly. The collar should be made in a somewhat stiffer material, such as cardboard or any other suitable material, so that the hand H can easily handle the collar without collapsing in the hand H. The collar is user-friendly and can easily be disposed of and will immediately decompose.

FIG. 2 shows the food item F as it is received in the collar 1. As can be seen from this view, the upper conical opening allows the person eating the food item F to eat without spilling any pieces or drips over the sides of the collar. At the same time the fingers of the person eating the food item are protected from being soiled because of the presence of the wrapping 2 protruding from the bottom of the collar. As the food F is being consumed, the fingers of the person eating the item have to merely push up on the wrapping through the collar 1.

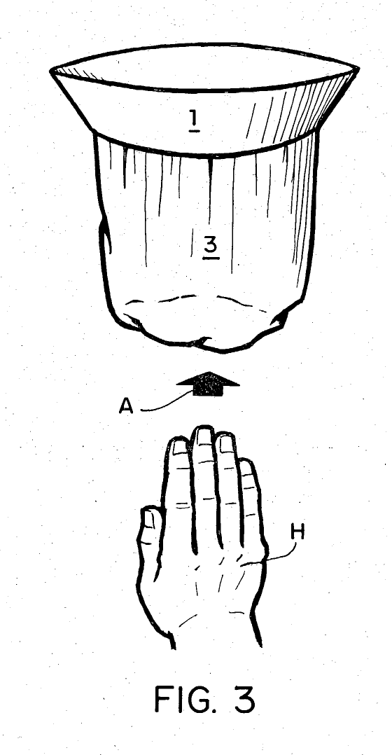

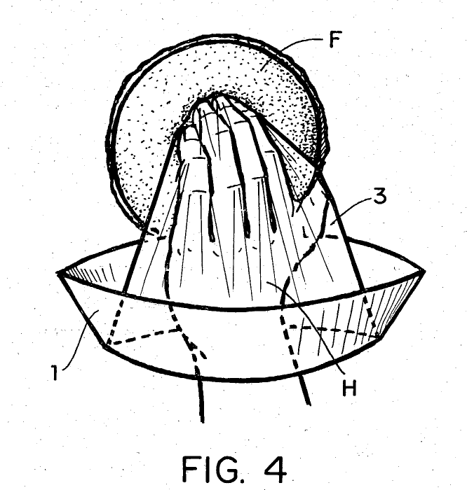

FIG. 3 illustrates a different embodiment wherein a flexible bag 3 is attached to the bottom of the collar 1. In this embodiment, the food, such a hamburger as it comes hot from the grill, can directly be placed into the bag 3, may be closed on top or the food can be eaten by pushing the hand H into the direction A into the bag 3 as is clearly shown in FIG. 4. This FIG. 4 again clearly shows the wide open top of the collar 1 whereby food spills or drips will be contained in the collar 1. The bag 3 could be made out of the same material as the presently used paper packaging or, of course, it could be some thin flexible decomposable plastic material which is spill and fluid impervious.

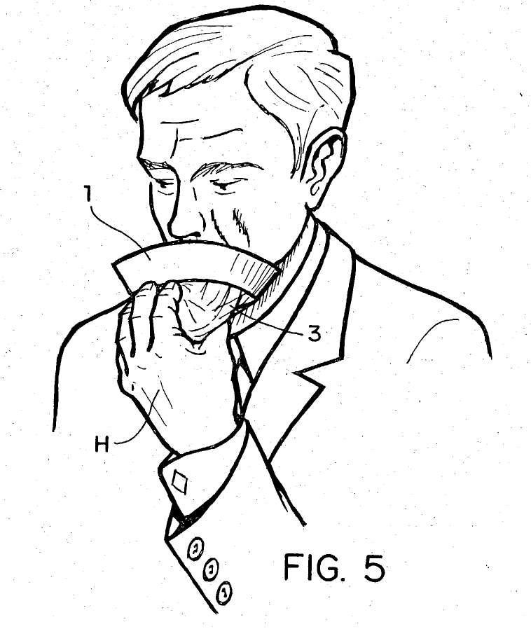

FIG. 5 illustrates the operation of the device of the invention as was depicted in previous Figs. It can clearly be seen that the upper end of the collar is wide enough to cover the mouth and the chin of the person, while at the same time protecting the fingers of the hand H from getting soiled by way of the bag material 3.

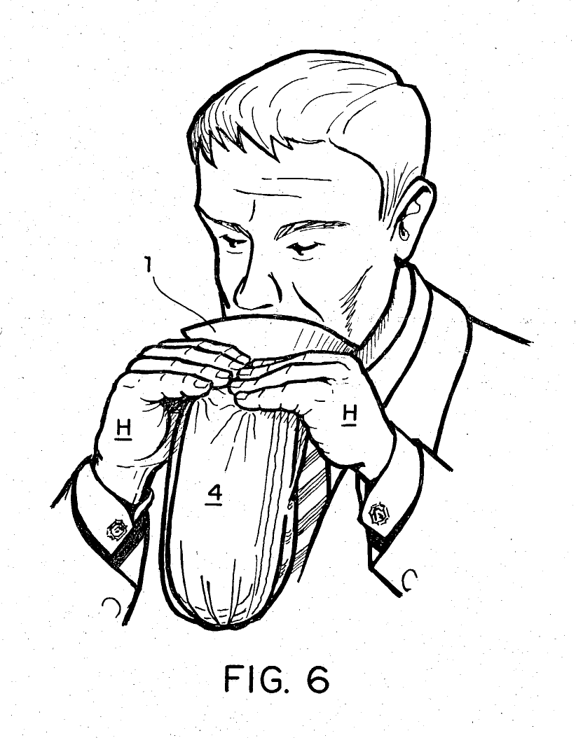

FIG. 6 illustrates the same concept as that shown and described in FIG. 5. In this description, there is shown a longer bag 4 attached to the earlier described collar 1. This is convenient when eating longer food items such as a “hot dog on a bun” or “Subway Sandwiches” Again it is clear that any spills, such as liquid or food particles will stay within the collar 1 and the fingers of the hand H, while moving the food item up until consumed will not be soiled.

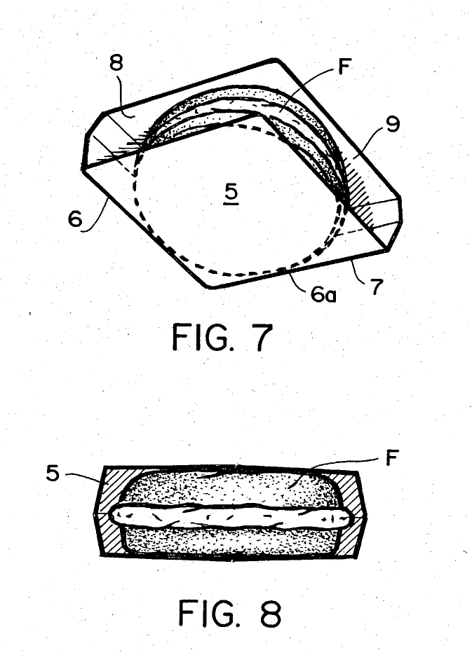

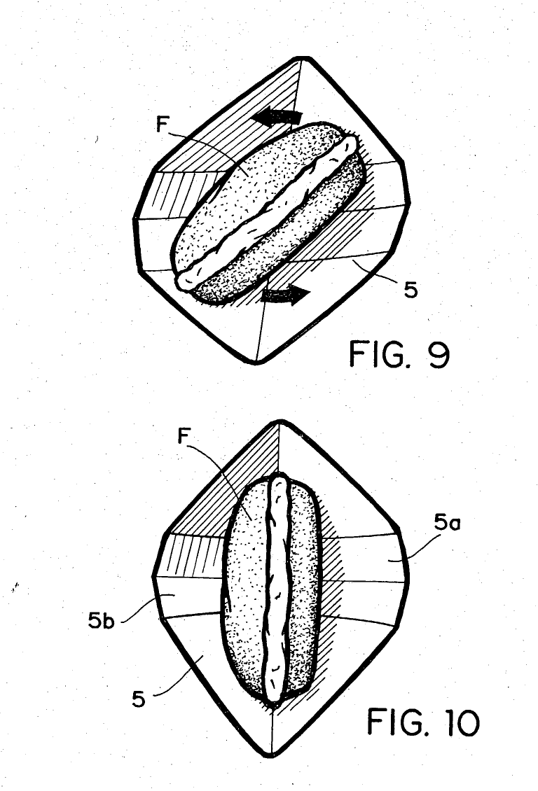

FIGS. 7-10 show a different embodiment of the invention at hand. FIG. 7, for example, shows a squared container which has two closed sides 6 and 7 and two open sides 8 and 9. It also could represent a pocket into which a ready grilled hamburger from the grill could be inserted. As shown in FIGS. 7 and 8, this hamburger could not be readily consumed unless taken out of this pocket. However, if the hamburger in this pocket is turned 90°, it opens up the pocket as is shown in FIGS. 9 and 10. FIG. 9 shows the pocket or receptacle from a top view just prior to turning the hamburger from its flat position in FIGS. 7 and 8. FIG. 10 shows the food item, the hamburger F, after it has been turned by 90° in the package 5. This turning results in that the sides of the former flat container 5 have opened up wide as is shown with the sides 5a and 5b in FIG. 10. This enables the person eating the food F to handle the Food F with the fingers being protected from any soiling and the wide open position as is shown in FIG. 10 from any drips or particles of food from spilling onto the person's clothing.

What I claim is:

1. A method of eating finger-held food without soiling the fingers or the clothing of a person eating said food, comprising the steps of providing a conical collar, said collar having a wide upper end and a lower narrower end, placing an item of food being covered in a wrapping into said collar with said food item protruding from an upper end of said collar and said wrapping protruding from a lower end of said collar, pushing said wrapping including said food upwardly toward a mouth of said person, said collar opening its upper end to an extent whereby spills or particles of food are caught within the confines of said wide upper end of said collar.

2. A device for capturing food spills and pieces of food from soiling clothing of a person eating said food, said device comprises a conical collar, said collar being wider in its upper end than at its lower end, said collar trapping an item of food within its confines, means for pushing an item of food upwardly toward said person's mouth, said collar opening wide toward said person's mouth including said person's chin.

3. The device of claim 2 including a bag attached to a lower end of said collar, said lower bag containing said food, means for pushing said bag upwardly to extend said food toward said person's mouth.

4. The device of claim 2, wherein said device is a rectangular package having two open sides and two closed sides.

5. The device of claim 4, wherein an item of food is being placed into said package and turned 90° will open said two open sides of said package to an opened mouthed container.
